(19) United States
(12) Patent Application Publication
(10) Pub. No.: US 2003/0126241 A1
(43) Pub. Date: Jul. 3, 2003

(54) Registration agent system, network system and program therefor

(75) Inventors: Masataka Nagura, Tokyo (JP); Hiroshi Kitamura, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/327,197

(22) Filed: Dec. 24, 2002

(30) Foreign Application Priority Data
Dec. 27, 2001 (JP) 2001-397073
Jun. 26, 2002 (JP) 2002-186266

(51) Int. Cl. G06F 15/16; G06F 15/177

(52) U.S. Cl. 709/221; 709/245; 707/104.1

(57) ABSTRACT

A registration agent system that registers information that must be registered to enable a node newly added to a network to commence communication. This registration agent system performs registration without a newly added node or a node manager of a newly added node having to know the location of a node managing structural information of the network or procedures for registration. Further, this registration agent system controls what information is registered and what information is not registered.

### BACKGROUND OF THE INVENTION

1. Field of the Invention

The present invention is used for a DNS (Domain Name System). More specifically, the invention relates to a system that performs registration procedures when the host name of a node is corresponded with a previously registered IP address and registered in a DNS server. This invention was made for use for a DNS but it can be widely applied for a network system with procedures for registering in a database installed in a network, identifying information of a node and further information related to that node corresponded to the identifying information.

2. Description of Related Art

In order to begin using a node connected in a network and enable the node to perform actual operations a node manager performs settings to acquire an address for the node. Further, it is necessary to set a variety of information concerning that additional node in a node managing structural information of the network. In order that other nodes on the network can identify a newly added node, and use the services provided by the added node the information set must be registered in a variety of nodes managing structural information of the network.

A problem arising here is that the added node must be registered against all necessary nodes providing structural information of the network. The added node must then know the location of all nodes providing a variety of structural information of the network that the node must be registered with, however because a node that is not at that time operating on the network is unable to acquire that kind of information from the network, complex processes are required to enable such non-operating node to receive such information from another node that was operating.

Further, there is a problem that even if the added node knows the location of nodes providing structural information on the network, in order to avoid work by the node manager of nodes providing structural information of the network, it must be possible to perform registration from an external source through the added node itself. However, for registration of such a node to be performed, additional procedures must be implemented enabling registration of the node against all nodes providing structural information on the network.

Technology of the prior art for solving these problems is seen in the inventions of JP2001-202316A or JP2001-216240A. These disclose systems wherein a newly added device is detected automatically and information for that device is automatically registered in a directory server. Further, JPH10-13443A discloses technology wherein an address is automatically allocated for a newly added client and that address is automatically notified to a network manager. Again, the invention disclosed in WO99/49619 discloses technology using an agent server that performs registration of an address and a pre-setting request in response to a request from a communication terminal.

With these existing technologies an address allocated for a newly added node including a device, client or communication terminal can be registered automatically in a database for example, but there is no technology for DNS proposed in the prior art.

In other words, with a DNS a host name and IP address can be corresponded one-to-one and registered so that a node can be identified from either the host name or the IP address. A host name for such a DNS can be set to anything as decided by the node manager. Accordingly this can include registration procedures wherein a node manager specifies a host name for an automatically allocated IP address and this name is written-in to a registration request and transmitted to a DNS server. In any of the above-mentioned existing technologies of the prior art however, there is no suggestion of any technology which includes such registration procedures.

Further, a host name specified by a node manager can still be registered even if an identical host name is already registered in the DNS server database. If however, an IP address is to be specified from a host name, when host names are duplicated in one database two IP addresses would be returned making it difficult to accurately specify the IP address of a node. In order to avoid such host name duplication the node manager must monitor the system and there is no prior art proposing any technology wherein the complexities of ascertaining the existence or otherwise of such duplication can be performed in place of a node manager.

### SUMMARY OF THE INVENTION

In order to solve the above problems the present invention discloses a system that acts as an agent instead of a node manager dynamically performing registration of information to a node that provides structural information of the network. That is to say, objects of the present invention are: to provide a network system wherein registration of an added node can be performed without requiring that the node knows the location of a node that manages structural information of the network on which the information for the added node must be registered; to provide a network system wherein it is not necessary for that node to know procedures for registering information; to provide a network system that can implement control over registration; and to provide a registration agent system that brings improved convenience and efficiency to a user.

What characterizes the present invention is that, in a communication environment in which a plurality of nodes participate dynamically on a network, it enables performance of registration through an agent, of information that must be registered in a node managing structural information of that network for to enable a node that has newly joined the network to commence communication.

A first effect of the present invention is that an added node can be registered without that node needing to know the location of a node managing structural information of the network on which information for the added node must be registered. This is because a registration agent system knows the location of a node managing structural information of the network and that system can perform the registration.

A second effect of the present invention is that it is not necessary for an added node to know procedures for registering information because the registration agent system knows procedures required for registration, and registration can be performed by that system when an added node makes a registration request to that system.

A third effect of the present invention is that control over registration can be implemented because such registration agent system can implement overall registration control through implementing control over the kind of information that should be registered and information that should not be registered.

That is to say a first aspect of the present invention is a registration agent system provided in a network system comprising nodes and at least one database for storing the correspondence of the IP address and the host of each node wherein the registration agent system comprises a registration request reception means for receiving the registration request including a host name and IP address from a node newly added to that network and a searching means that, instead of that node, searches that database for the host name included in the registration request received, and a registration means that instead of that node, registers that host name and the IP address of the node concerned in the database if the result of the searching by the searching means is that the host name is not registered.

Installation of this registration agent system in that network system brings improved convenience to a user by making it sufficient for a node or a node manager to simply acquire the information needed to access the registration agent system or to simply provide a node with functionality enabling access to the registration agent system.

It is preferable for the network system to be configured with a plurality of such databases installed with one for each different domain and for storing the correspondence of an IP address and a host name, and for the registration agent system to comprise a means for specifying from those databases the individual database that is for the domain pertaining to the IP address subject to searching and registration operations.

In this way, a database in which registration is performed can be specified from within a network system comprising a plurality of databases and a decision as to whether or not registration should be performed can be made.

Registration can be performed using a host name with attached domain information containing information added on the domain pertaining to the IP address corresponded to the host name, so it is preferable, where a plurality of databases are installed with one for each different domain, for the registration agent system to further comprise a generating means for generating as the host name for registration in the specified database, a host name included in the registration request from the node added to the network, which host name has attached domain information containing added information on the domain pertaining to the IP address of such newly added node.

Accordingly, there is no need for a node or a node manager to themselves add information on a domain pertaining to an IP address corresponded to a host name, thereby bringing improved convenience to the user.

Thus, with this invention registration of duplicate host names can be automatically avoided. This results in improved efficiency for a node or node manager by enabling a reduction in effort spent conducting advance checks to ascertain whether duplication has occurred. Further, any attempt to “impersonate” an existing node can be prevented.

It is preferable for the registration request reception means to include a storage means for storing characters use of which is prohibited and a means for refusing a registration request that contains a host name using a character stored in this storage means.

That is to say, with the present invention, the registration agent system can recognize in advance a character such as a letter, numeral or symbol usage of which is prohibited, so that when a registration request including such a character arrives that request is refused. Accordingly, this avoids the problem of a host name including a character that cannot be used being registered by mistake, as the check procedures performed by a node or node manager are performed by the system acting as an agent instead, resulting in an improved level of efficiency for a user.

The registration agent system may be installed with a detection means for detecting a node newly added to the network, which detection means includes a recognition means for recognizing the IP address of such detected node and a generation means for generating a host name of the node corresponded to the IP address recognized by the recognition means and a transmission means for transmitting, instead of the newly added node transmitting, to the registration request reception means a registration request including the host name generated by the generation means and the IP address.

Accordingly, this renders it unnecessary for a newly added node or its node manager to acquire even information on the IP addresses of the registration agent system in advance, thereby bringing improved efficiency and convenience to the node manager. Further, it becomes unnecessary for the node manager to specify a host name and this decreases the workload of the node manager.

It is preferable for the registration agent system to comprise a preliminary searching means that operates before the searching from the searching means to search the database for the IP address included in the registration request received, and an invalidating means that operates when the result of such searching operation by the preliminary searching means indicates that registration of the IP address is already complete, to invalidate the registration request before the searching operation by the searching means for the host name.

When a detection system providing a means for detecting such a node newly added to a network is installed in that network system, then once the host name and IP address of the node are registered in the database, even if a situation arose in which the node became detached from the network and subsequently recovered on the network, the detection system would automatically detect that that node was again participating on the network.

Here, when that detection system detects participation of that node on the network that equipment would acquire the IP address for the node and automatically generate a host name before sending the registration request to the registration agent system of this invention. Upon receiving this registration request the registration agent system would search the database through the host name included in the registration request.

Now, the detection system would generate a host name different to a host name already registered in the database. Accordingly, the result of an operation to detect host name duplication executed by the registration agent system would be a decision of “no duplication.” In fact however, registration in the database of the host name and IP address for the node would be already complete. Regardless, the registration agent system would register that host name and IP address corresponded to the host name in that database based on the “no duplication” result as decided. Thus the same IP address would come to be registered in duplicate in that database. This would result in two different host names coordinated to this same duplicated IP address being registered causing confusion in that database.

To avoid this situation occurring, before sending the registration request from the detection system to the server managing that database, the registration agent system according to the present invention knows, through searching that database based on the IP address, whether or not the IP address of that node is already registered. The registration agent system sends the registration request from the detection system to the server only if the IP address is not registered. Accordingly, the situation of two host names being mistakenly registered for a duplicated IP address is avoided, thereby avoiding the problem of confusion occurring in the database.

The second aspect of the present invention is a network system in which is provided a registration agent system of the present invention.

The third aspect of the present invention is a program which can be installed in an information processing system provided in a network comprising nodes and at least one database for storing the correspondence of the IP address and the host name of each node to realize functions in that information processing system for: receiving a registration request including a host name and IP address from a node newly added to the network in which that information processing system is installed, and for searching, instead of that node searching, the host name included in the registration request received in at least one database installed in that network for storing the correspondence of host name and IP address for each individual node, and registering that host name and relevant IP address in that database if the result of that searching is that the host name is not registered.

It is preferable for the program of this invention to be programed for the information processing system where that system operates in a network system in which a plurality of databases are installed with one for each different domain for storing the correspondence of an IP address in a host name, and to realize a function for specifying from those databases the individual database that is for the domain pertaining to the IP address subject to the searching and registration operations.

Here, it is preferable for the program to further realize a function for generating as the host name for registration in the specified database, a host name included in the registration request from the node added to the network, which host name has attached domain information containing added information on the domain pertaining to the IP address of the node.

Further, it is preferable for the program to realize as the registration request reception function: a function for storing characters use of which is prohibited and a function for refusing a registration request that contains a host name using a character stored through this storage functionality.

It is preferable for the program to realize a function for detecting a node newly added to the network which detection function realizes: a function for recognizing the IP address of such detected node, and a function for generating a host name of the node corresponded to such recognized IP address, and a function for transmitting, that acts instead of said node newly added to the network, to transmit to said registration request reception function a registration request including the generated host name and the IP address.

Further, it is preferable for the program to realize functions for preliminary searching said specified database for the IP address included in a received registration request before searching for the host name, and invalidating, when the result of such preliminary searching operation indicates that registration of the IP address is already complete, the registration request before searching for the host name.

Through recording the program of this invention onto a recording medium that medium can be used to install the program of this invention in the information processing equipment. Or, the program of this invention can be installed directly in that information processing equipment via a network from a server holding the program.

The description above explains how a registration agent system that brings improved efficiency and convenience to a user can be realized through information processing equipment like a computer for example. That is to say, the present invention realizes: a network system wherein registration of an added node can be performed without requiring that the node knows the location of a node that manages structural information of the network on which the information for the added node must be registered; a network system wherein it is not necessary for an added node to know procedures for registering information; and a network system that can implement control over registration.

### BRIEF DESCRIPTION OF THE DRAWINGS

Specific embodiments of the present invention will now be described, by way of example only, with reference to the accompanying drawings in which:

FIG. 1 shows the configuration of a network system according to a first embodiment of this invention;

FIG. 2 shows the sequence of registration procedures performed according to the first embodiment of this invention;

FIG. 3 shows the sequence of registration refusal procedures executed when a host name is duplicated, according to the first embodiment of this invention;

FIG. 4 shows the configuration of a network system according to a second embodiment of this invention;

FIG. 5 shows the sequence of registration procedures performed according to the second embodiment of this invention;

FIG. 6 shows the configuration of a network system according to a third embodiment of this invention;

FIG. 7 shows the sequence of registration procedures performed according to a third embodiment of this invention;

FIG. 8 shows the configuration of a registration agent system according to a fourth embodiment of this invention; and

FIG. 9 shows the sequence of registration procedures performed according to the fourth embodiment of the present invention.

### DETAILED DESCRIPTION OF THE PREFERRED EMBODIMENTS

First Embodiment

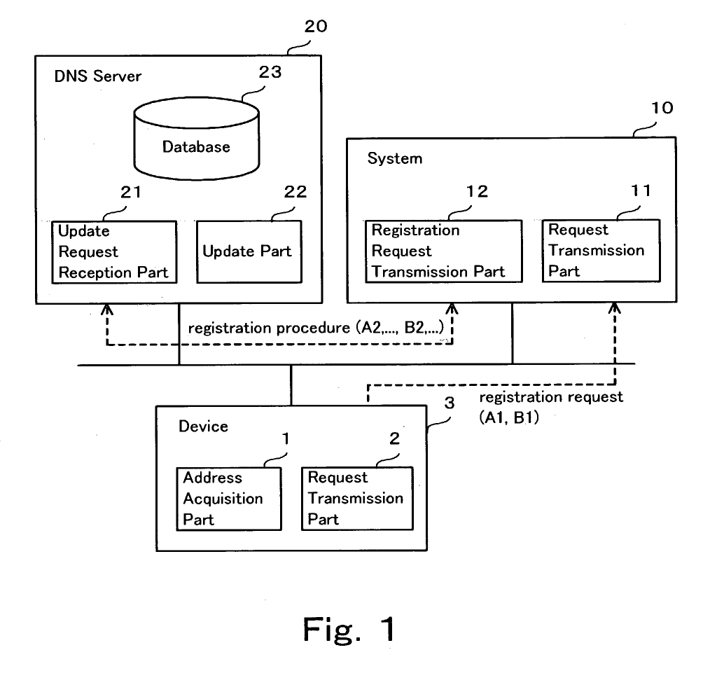

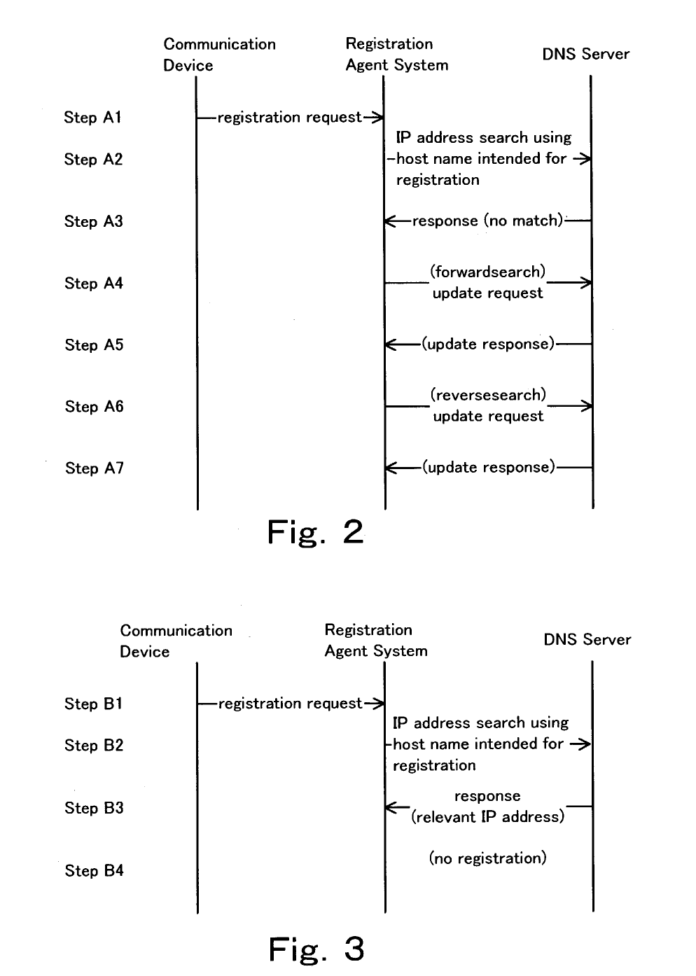

A registration agent system and network system according to a first embodiment of this invention will now be described with reference to FIGS. 1 through 3. FIG. 1 shows the configuration of a network system according to a first embodiment of this invention. FIG. 2 shows the sequence of registration procedures performed according to a first embodiment of this invention. FIG. 3 shows the sequence of registration refusal procedures executed when a host name is duplicated, according to the first embodiment of this invention.

As shown in FIG. 1 the present invention provides registration agent system 10 installed in a network system comprising communication device 3 that is a node comprising address acquisition part 1 and request transmission part 2 through which a host name corresponded to an IP address allocated to that node itself can be set by a node manager and that transmit a registration request including the host name and the IP address corresponded to the host name, and DNS server (#1) 20 comprising update request reception part 21, update part 22 and database 23 that operate in response to the registration request, storing the correspondence of the IP address of the node and the host name.

This registration agent system 10 comprises registration request reception part 11 that receives such registration request and registration request transmission part 12 that searches database 23 for the host name included in such registration request to decide whether or not registration of the host name is complete, when this registration request reception part 11 receives that registration request, and that makes the correspondence between the host name with the IP address and registers it in database 23 when the result of the decision indicates that the host name is not registered.

Again, request reception part 11 provides memory (not shown in the drawings), that stores characters such as letters, numerals or symbols usage of which is prohibited and refuses any registration request including a host name using a character stored in this memory.

An example of registration agent system 10 sending a registration request to DNS server (#1) 20 according to this first embodiment will now be described. Referring to FIG. 1, when communication device 3 is added to the network, the information for device 3 is registered in 10 DNS server (#1) 20 that manages structural information of the network. In order to achieve this objective, registration agent system 10, a system that acts as an agent to register information on communication device 3, is provided.

Communication device 3 that is added to the network, includes address acquisition part 1 and request transmission part 2. When communication device 3 is added to the network, firstly, address acquisition part 1 acquires and sets an IP address for device 3 and the information set is transmitted to registration agent system 10 through request transmission part 2. Allocation of the IP address to communication device 3 is not directly concerned with this invention and is therefore not described in detail here. Methods that may be used include the state-less address setting method where setting of the IP address is performed through the added communication device 3 itself or the state-full address setting method where an appropriate IP address is acquired from communication system managing the allocation of addresses, in response to a request issued from the added communication device 3. IETF recommendation RFC 197 discloses a mechanism for state-less address setting while a DHCP (Dynamic Host Configuration Protocol) server is well-known as communication equipment managing the allocation of addresses for the performance of state-full address setting.

Registration agent system 10 includes request reception part 11 and registration request transmission part 12. Registration agent system 10 creates and issues a registration request to DNS server (#1) 20 managing structural information of the network after receiving a registration request sent from the newly added communication device 3.

DNS server (#1) 20 that manages structural information of the network includes update request reception part 21, update part 22 and database 23. Upon receiving a request from registration agent system 10, update request reception part 21 responds to that request by activating update part 22 and update part 22 performs the registration in database 23.

Thus, as registration agent system 10 performs the registration instead of communication device 3 that commences participation on the network, it is not necessary for device 3 to know the location of DNS server (#1) 20 that manages structural information of the network. Further, it is unnecessary for the newly added device 3 to know registration procedures concerning registration for structural information of the whole network because system 10 performs the registration.

Further, it may be unclear whether the communication device 3 that was newly added to the network is legitimate or not. Here, upon receiving a registration request, registration agent system 10 investigates whether or not the host name therein is already registered and sends a registration request to DNS server (#1) 20 managing structural information on the network thereby providing advance protection against an illegitimate operation such as “impersonation” of a node. This enables registration to be performed in a safer environment. Again, in a situation where a character usage of which is prohibited is used in a host name, upon receiving the registration request system 10 checks for the existence of such character before sending the registration request to DNS server (#1) 20 managing structural information of the network, thereby avoiding a situation in which a host name that cannot be used is registered by mistake.

Viewed from the perspective of a manager of communication device 3, if it occurs that registration in database 23 of the host name specified by the manager is already complete, the host manager is prevented from registering a duplicate host name by mistake because registration agent system 10 refuses the registration request. Again, this system enables avoidance of the problem of a host name that cannot be used being mistakenly registered. Accordingly, viewed from the perspective of a manager, it enables registration operations to be performed more safely. Additionally, {as the format of a request directed to DNS server (#1) 20} is acquired through registration agent system 10, it is not necessary to change the functions of communication device 3 or DNS server (#1) 20. Thus registration in a database managing information required for communications can be performed dynamically through the registration agent system.

Next, the overall operations executed through the first embodiment of this invention will be described in detail with reference to FIG. 2. The description of FIG. 2 pertains to one DNS server, taken here as referring to DNS server (#1) 20 of FIG. 1. Firstly, processes required for performing communication such as physically connecting things like cables and providing power supply are performed and communication device 3 newly participating on the network is connected up to that network.

Then, the first procedure this communication device 3 performs is acquisition and setting of an IP address through address acquisition part 1 inside communication device 3.

Here, with this first embodiment, dynamically registered information is dynamic registration of an entry in database 23 of DNS server (#1) 20 managing host names.

Because the host name of communication device 3 is set by the node manager, after it commences participating on the network, device 3 must become capable of being referenced by another communication device using that host name. To achieve this, once the host name of device 3 is set an entry must be recorded in database 23 in order to define the correspondence between that host name and that IP address to enable another communication device to reference that newly participating device 3 using that host name.

Accordingly, the node manager decides the host name for this communication device 3 which already has an IP address set.

Device 3 sends to registration agent system 10 a registration request with this host name for registration (step A1). At this point, request reception part 11 decides whether or not a character used in this host name for registration included in the registration request is a character subject to a pre-existing prohibition and accepts only a registration request containing a host name that uses a character other than such prohibited character. This is the same for the subsequently described embodiments of this invention and is therefore omitted from the descriptions of those embodiments.

Registration agent system 10 sends the host name of communication device 3 intended for registration to DNS server (#1) 20 to investigate whether or not an IP address coordinated to this host name for registration has been extracted (step A2). DNS server (#1) 20 searches database 23 using the host name for registration thus delivered. That server ascertains whether or not an IP address corresponding to that host name is present and issues a reply (step A3). As shown in the example of FIG. 2 “No match” is returned. Next, registration agent system 10 uses the IP address of communication device 3 and that host name and performs registration in DNS server (#1) 20 in a format enabling forward searching to be conducted so the IP address can be referenced from that host name (step A4, step A5). In the same way, system 10 performs a registration in a format enabling reverse searching to be conducted so the host name can be referenced from the IP address (step A6, step A7).

Update request reception part 21 of DNS server (#1) 20 that receives the request from registration request transmission part 12 of registration agent system 10, responds to that request by starting up update part 22 which updates database 23.

Here, the mechanism of Dynamic DNS, as disclosed in RFC 2136 of IETF, is used to perform the registration of the host name dynamically in DNS server (#1) 20. Using dynamic DNS enables registration of name information dynamically in that server.

This embodiment will now be described in terms of a concrete example. As shown in FIG. 1 communication device 3 has commenced participating on the network. This communication device 3 first performs acquisition and setting of an IP address through address acquisition part 1. The node manager of device 3 sets the host name as “samplehost” and device 3 sends a registration request including that IP address and the host name intended for registration to registration agent system 10. System 10 adds a character string for domain identification to that host name and performs a registration in DNS server (#1) 20 using the host name “samplehost.example.com” with domain name added and the IP address of communication device 3. There are two types of registration performed here: registration enabling a forward search where the IP address can be referenced from the host name “samplehost.example.com” and registration enabling a reverse search where the host name “samplehost.example.com” can be referenced from the IP address. In this way another communication part on the network becomes able to reference the newly ended communication device 3 through the name “samplehost.example.com”.

Next, this embodiment will be described with reference to the situation where a host name defined for communication device 3 should not be registered because it matches a host name existing from a previous entry in database 23. The sequence occurring in this situation is shown in FIG. 3. The communication device 3 that has commenced participating on the network sends a registration request including the host name and IP address to registration agent system 10 (step B1). In order to investigate whether or not this host name intended for registration is already being used, system 10 sends that host name to DNS server (#1) 20 for a determination on whether or not an IP address corresponding to that host name has been extracted (step B2). In the example shown in FIG. 3, the response from that server is that an IP address has been extracted (step B3). Accordingly, system 10 knows that this host name intended for registration and about to be registered has already been registered and so system 10 refuses the request (step B4).

That is to say, as DNS server (#1) 20 stores the specified host name a conflict with an existing host name in that domain may occur. Further, a situation could occur in which registration is performed using the same name as a communication part performing an important role on the network by managing structural information for the network, resulting in “impersonation” of that important communication part and rendering it incapable of performing its role. Here however registration agent system 10 investigates whether or not a clash of host names would occur and only performs the registration when there would not be a clash thereby preventing such “impersonation” resulting.

Again, registration agent system 10 performs an investigation before making a registration request for the host name to DNS server (#1) 20 thereby preventing registration of a host name that uses a character use of which is prohibited for a host name.

In this way, registration of communication device 3 added to the network can be performed without requiring that device 3 knows the location of DNS server (#1) 20 that manages structural information of the network on which the information for device 3 must be registered. Further, it is not necessary for the added communication device 3 to know procedures for registering information and it becomes possible to implement control over registration operations.

Second Embodiment

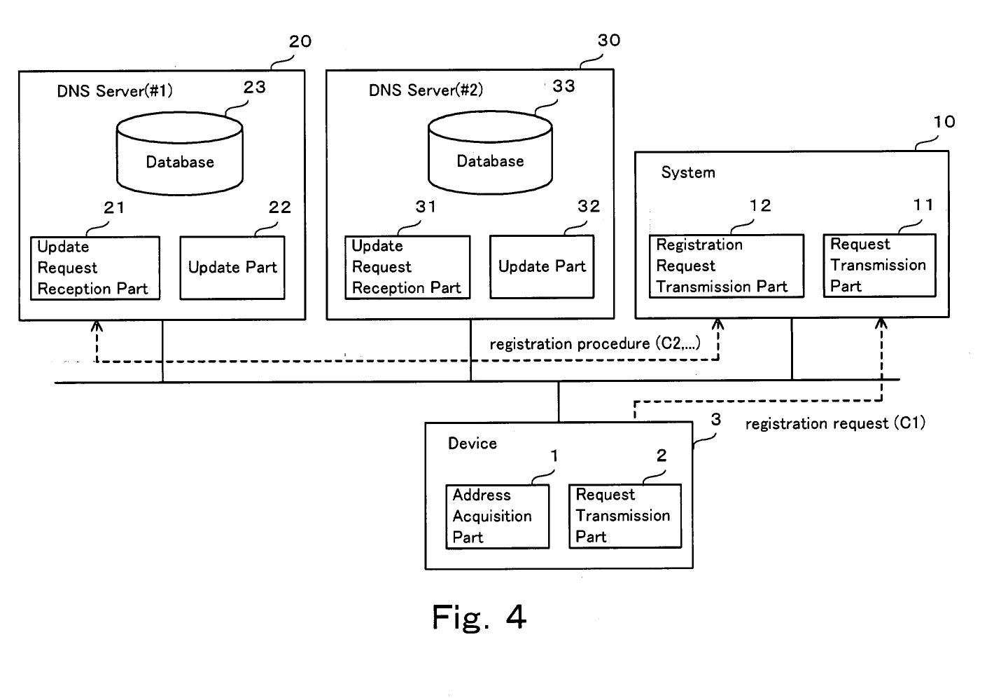

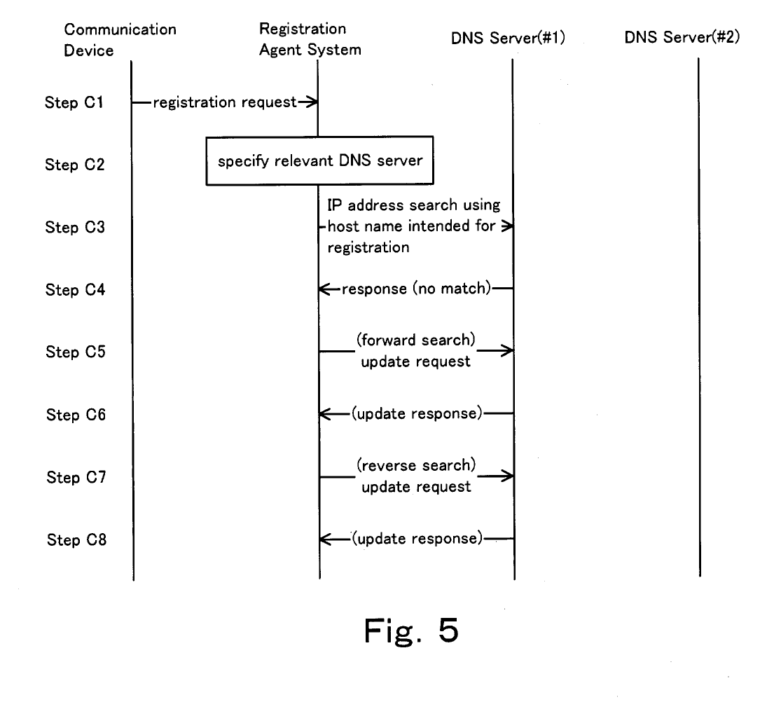

A second embodiment of the present invention will now be described with reference to FIGS. 4 and 5. FIG. 4 shows the configuration of a network system according to a second embodiment of this invention. FIG. 5 shows the sequence of registration procedures performed according to the second embodiment of this invention. With this second embodiment DNS servers (#1) 20 and (#2) 30 are installed each in different domains as shown in FIG. 4. Here, registration request transmission part 12 searches database 23 or 33 for the IP address included in the registration request and when deciding whether or not registration of the host name corresponded to that IP address is already complete, specifies DNS server (#1) 20 or (#2) 30 as the server for the domain pertaining to the IP address corresponding to the host name subject to that decision.

According to whichever of DNS server (#1) 20 or (#2) 30 is thus specified, Part 12 serches database 23 or 33 for that IP address included in that registration request and decides whether or not registration of the host name corresponded to that IP address is already complete.

Then, registration request transmission part 12 generates a host name with attached domain information containing information added on the domain pertaining to the IP address corresponded to the host name and registers the host name in the database 23 or 33 as the case may be.

That is to say, for this embodiment, firstly processes required for performing communication such as physically connecting things like cables and providing power supply are performed and communication device 3 newly participating on the network is connected up to that network.

Then, the first procedure this newly connected communication device 3 performs is acquisition and setting of an IP address through address acquisition part 1 inside that device 3. This communication device 3 with such settings newly made sends to registration agent system 10 a registration request including the host name intended for registration as decided by the node manager of device 3 and the IP address (step C1).

The IP address included in this registration request is referenced by system 10 which then specifies either DNS server (#1) 24 (#2) 30 as the server for the domain pertaining to the IP address (step C2). In the example shown in FIG. 5 DNS server (#1) 20 is the domain pertaining to that IP address.

System 10 then sends the host name of communication device 3 intended for registration to DNS server (#1) 20 to investigate whether or not an IP address coordinated to this host name for registration has been extracted (step C3). DNS server (#1) 20 searches its own database 23 for the host name for registration thus delivered and issues a response (step C4). In the example shown in FIG. 5, that response is “no match”. Receiving this response, registration agent system 10 uses the host name set for communication device 3 and the IP address of communication device 3 and performs the registration in DNS server (#1) 20 in a format enabling forward searching to be conducted so the IP address can be referenced from that host name (step C5, C6). In the same way, system 10 performs the registration in a format enabling reverse searching to be conducted so the host name can be referenced from the IP address (step C7, C8).

This second embodiment will now be described in terms of a concrete example. As shown in FIG. 4 communication device 3 has newly participated on the network. This communication device 3 first performs acquisition and setting of an IP address through address acquisition part 1. Here we envisage that this results in the setting of an IP address that pertains to domain A that is the domain managed by DNS server (#1) 20.

Where the node manager of device 3 sets the host name as “samplehost” device 3 sends a registration request including that IP address and that host name to registration agent system 10.

Registration agent system 10 first investigates to ascertain which domain pertains to the IP address included in that registration request. If as a result of that investigation system 10 detects that the registration request is for an IP address of domain A system 10 adds to that host name a host name character string showing that the domain is domain A. Using the character string “samplehost.example-a.com” with domain name added and the IP address of communication device 3, registration agent system 10 performs a registration through the appropriate server, DNS server (#1) 20, with registrations enabling a forward search and a reverse search to be conducted. Thus, another communication device becomes able to reference this newly added communication device 3 through the host name “samplehost.example-a.com”.

In the same way, where registration agent system 10 acting as agent registering several services, such as for an NIS (Network Information Service) that provides unified management for setting information for communication parts on other DNS servers or networks, system 10 decides which service is appropriate from the request it has received and can then perform the registration in the appropriate service.

Third Embodiment

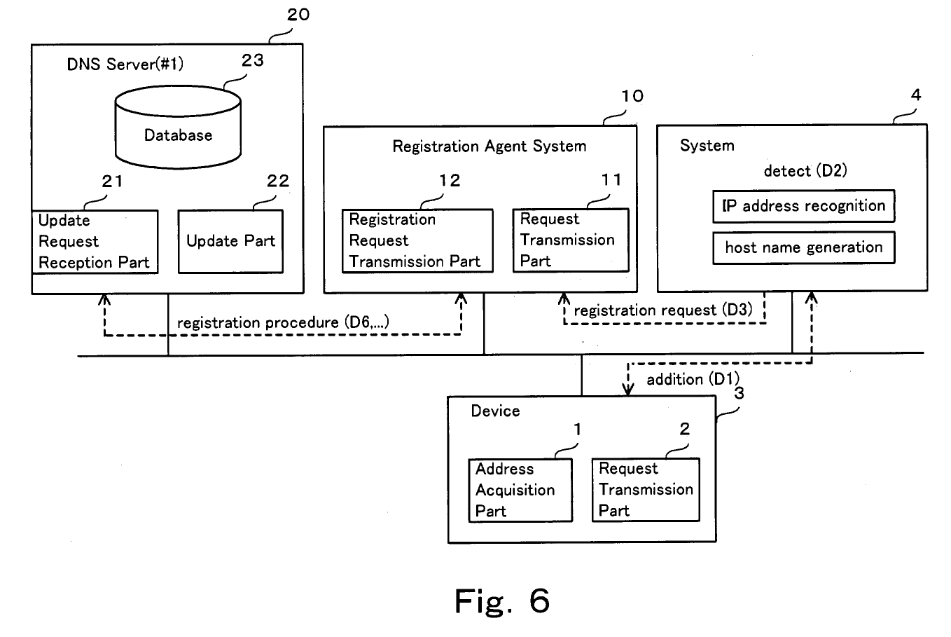

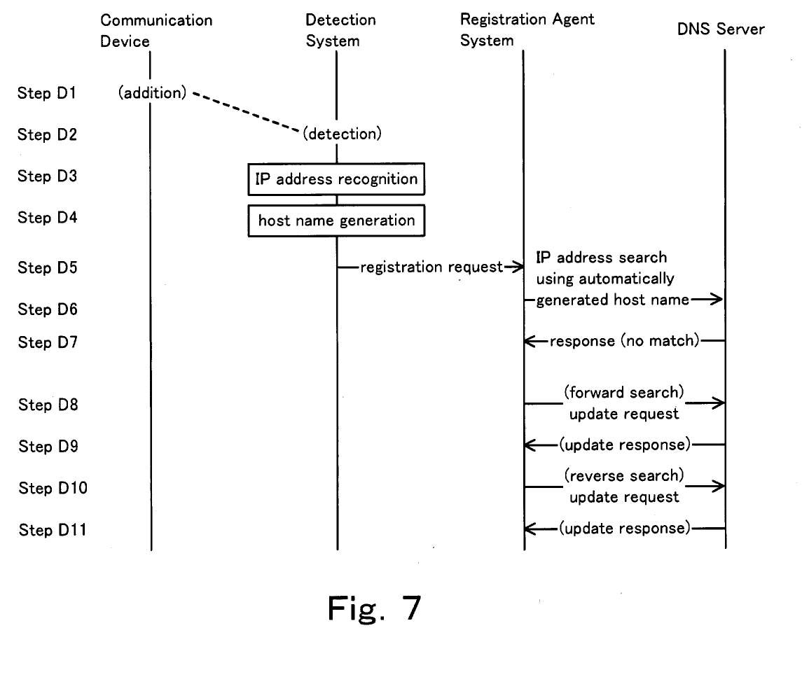

A third embodiment of this invention will now be described with reference to FIGS. 6 and 7. FIG. 6 shows the configuration of a network system according to a third embodiment of this invention and FIG. 7 shows the sequence of registration procedures performed according to a third embodiment of this invention. As shown in FIG. 6, in this third embodiment detection system 4 is installed to detect communication device 3 when device 3 is newly added to the network. This detection system 4 recognizes the IP address of communication device 3 and generates a host name for communication device 3 corresponded to that IP address. Part 4 then sends to registration agent system 10, a registration request including that generated host name and that IP address. In FIG. 6 only DNS server (#1) 20 is indicated in order to simplify the explanation however a plurality of DNS servers may be installed as shown in FIG. 4.

The overall operations occurring according to this third embodiment will now be described with reference to FIG. 7. The communication device 3 is added to the network (step D1) and once an IP address for device 3 has been acquired and set through address acquisition part 1, detection system 4 detects this newly added communication device 3 (step D2). The method used for this detection is not directly related to this invention and therefore a detailed explanation is not provided here but this method may include the state-less address setting method as described above wherein setting of the IP address is performed through the added communication device 3 itself or the state-full address setting method wherein the added communication device 3 issues a request to the communication part managing allocation of addresses which part then acquires and sets an appropriate IP address.

After detecting communication device 3, detection system 4 recognizes the IP address of device 3 (step D3) and generates a host name for device 3 (step D4). In this way, with this third embodiment, detection system 4 generates a host name without any involvement from a manager of communication device 3. Thus, one of the benefits resulting from this embodiment is that, for a manager of communication device 3, there is a decreased workload involved in specification of host names. Further, with the first and second embodiment of this invention, because a manager of communication device 3 specifies the host name, it is possible for this manager to reflect his own instruction policy in such host names. With this third embodiment, if a manager of communication device 3 desires to implement his own instruction policy in host names this can be accommodated through installing an instruction policy table in detection system 4 to enable a manager of communication device 3 to set a host name instruction policy in detection system 4 in advance.

When detection system 4 automatically generates a host name, system 4 sends to registration agent system 10 a registration request including this host name and the IP address acquired and set through acquisition part 1 (step D5). Upon receiving this registration request, system 10 sends the host name thus generated to DNS server (#1) 20 to investigate whether or not an IP address corresponded to this host name has been extracted (step D6). DNS server (#1) 20 uses the host name thus delivered to search the database and issues a response showing the result of that searching operation (step D7). In the example shown in FIG. 7, that response is “no match”. System 10 performs registrations in DNS server (#1) 20, with registrations enabling a forward search and a reverse search to be conducted (steps D8 through D11).

Thus, with this third embodiment communication device 3 newly added to the network is automatically detected and enables automatic performance of registration of a host name for that communication device 3 in DNS server (#1) 20. With this third embodiment, after detection system 4 has generated a host name, even though registration agent system 10 does not perform an inspection to detect duplicate host name registration, system 10 is able to inspect for the existence of such duplication through investigating the host name generation records of detection system 4. For example, once system 10 receives a new registration request system 10 first investigates the host name generation records of detection system 4 and if duplication is discovered at that point, system 10 refuses the registration request. If no such duplication is detected, system 10 then commences an inquiry to DNS server (#1) 20.

Fourth Embodiment

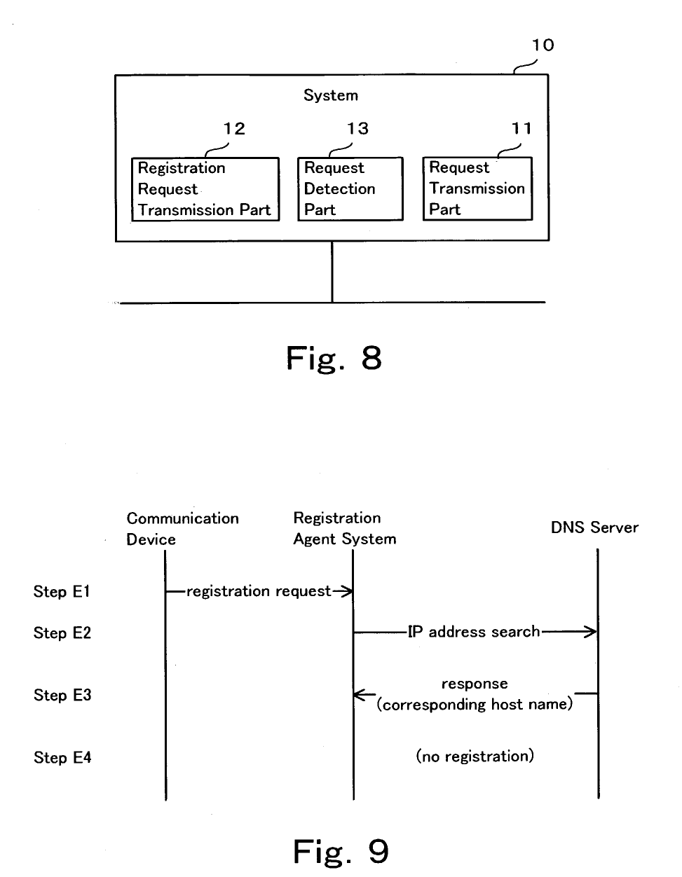

A fourth embodiment of this invention will now be described with reference to FIGS. 8 and 9. FIG. 8 shows the configuration of a registration agent system according to a fourth embodiment of this invention and FIG. 9 shows the sequence of registration procedures performed according to that embodiment. This fourth embodiment provides request detection part 13 that operates as a preliminary searching means acting before a decision is made through registration request transmission part 12 as to whether or not a host name is already registered, to research database 23 for the IP address included in the registration request and decide whether or not the IP address is already registered.

When the result of the decision through request detection part 13 is that registration of the IP address is already complete, part 13 invalidates that registration request before a decision is made by registration request transmission part 12 through the host name.

The operations of registration agent system 10 in this fourth embodiment will now be described with reference to FIG. 9. If there is a registration request from communication device 3 (step E1), request reception part 11 of system 10 receives that request and forwards it to request detection part 13. Part 13 performs a searching operation to determine whether or not the IP address included in that registration request is registered in database 23 (step E2). In the example shown in FIG. 9 that IP address is already registered in database 23 so database 23 issues as its response notification of the host name corresponding to that IP address (step E3). Upon receiving this response request detection part 13 discards the registration request forwarded to it thereby ensuring that registration is not duplicated (step E4).

If at step E3 the response issued provides no notification of a host name corresponding to that IP address it means that there is no registration of that IP address. In this situation the steps from step A2 onward in FIG. 2 or from step C3 in FIG. 5 are executed through registration request transmission part 12.

The example of FIG. 9 envisages a network installed with a detection system 4 described in relation to FIG. 6 of the third embodiment. Once a host name and IP address for communication device 3 are registered in database 23, if for example a situation arose in which communication device 3 is detached from the network and subsequently recovered on that network, detection system 4 would automatically detect that device 3 was again participating on the network.

If detection system 4 detects participation on the network by communication device 3, system 4 acquires the IP address of communication device 3, automatically generates a host name for device 3 and sends a registration request to registration agent system 10. Upon receiving this registration request, system 10 performs a searching operation in database 23 for the host name.

Here, detection system 4 would generate a host name different to a host name already registered in database 23. Accordingly, the result of an operation to detect host name duplication executed by the registration agent system 10 would be a decision of “no duplication”. In fact however, registration in the database of the host name and IP address of communication device 3 would be already complete. Regardless, registration agent system 10 would register that host name and IP address corresponded to the host name in database 23 based on the “no duplication” result as decided. Thus the same IP address would come to be registered in duplicate in that database. This would result in two different host names coordinated to this same duplicated IP address being registered causing confusion in that database.

To avoid this situation occurring, with this fourth embodiment, before registration request transmission part 12 sends the registration request from detection system 4 to DNS server 20, registration agent system 10 knows, through the searching of database 23 conducted by request detection part 13 of system 10 for the IP address, whether or not an IP address of communication device 3 is already registered in database 23. Based on that, registration request transmission part 12 only sends the registration request from detection system 4 to DNS server 20 when that IP address is not registered. Accordingly, the situation described above of two host names being mistakenly registered is avoided, thereby avoiding the problem of confusion occurring in database 23.

Fifth Embodiment

A registration agent system and a detection part according to any of the first through to the fourth embodiments of this invention can be realized through utilizing a computer. The fifth embodiment of this invention is a program which through installation in a computer} realizes in that computer functions for a registration agent system installed in a network comprising nodes and at least one database. In this example registration agent system 10 is envisaged operating in a network comprising DNS servers (#1) and (#2) providing databases 23 and 33 respectively.

The functions for that registration agent system 10 comprise functions for: receiving a registration request including a host name and IP address from a node newly added to the network in which that information processing system is installed, searching, instead of the node searching, at least one database installed in said network for storing the correspondence of host name and IP address for each individual node using the host name included in the registration request received, and registering that host name and relevant IP address in the database if the result of that searching is that the host name is not registered.

Again, where in such network system the database 23 and the database 33 are installed each for a different domain, installation in a computer of the program according to this fifth embodiment of this invention realizes in that computer a function for: specifying from those databases the individual database that is for the domain pertaining to the IP address subject to the searching and registration operations.

Moreover, installation in a computer of the program according to this fifth embodiment of this invention realizes in that computer a function for: generating as the host name for registration in the specified database, a host name included in a registration request from the node to the network, which host name has attached domain information containing added information on the domain pertaining to the IP address of the node.

Further, installation in a computer of the program according to this fifth embodiment of this invention realizes in that computer a function for: storing characters prohibiting use and refusing a registration request that contains a host name using a character stored through this storage function.

Moreover, installation in a computer of the program according to this fifth embodiment of this invention realizes in that computer functions for: recognizing the IP address of such detected node, generating a host name of the node corresponded to such recognized IP address and transmitting, instead of the newly added node transmitting, the registration request including the generating host name and IP address to the registration request reception function.

Further, installation in a computer of the program according to this fifth embodiment of this invention realizes in that computer functions for: preliminary searching that operates before the searching through the function for searching, to search the database using the IP address included in a received registration request and invalidate the registration request before the searching through the searching function using the host name, when the result of such searching operation by the preliminary searching function indicates that registration of the IP address is already complete.

Through recording the program of this fifth embodiment of this invention onto a recording medium that medium can be used to install that program in a computer. Or, the program of this embodiment can be installed directly in a computer from a server holding the program via a network.

Thus, the registration agent system of this embodiment can be realized through a computer. That is to say, this enables registration of the added communication device 3 to be performed without requiring that device 3 knows the location of DNS server (#1) 20 or DNS server (#2) 30 that manage structural information of the network on which the information for that added communication device 3 must be registered. Further, this enables realization of a network system wherein it is not necessary for the added communication device 3 to know procedures for registering information. Moreover it realizes a network system that can implement control over registration.

As described, according to this invention registration of an added node can be performed by a registration agent system without requiring that that added node knows the location of a node that manages structural information of the network on which the information for the added node must be registered; it is not necessary for an added node to know procedures for registering information; it becomes possible to implement control over registration of a node or communication part on that network. This brings improved convenience and efficiency to the user.

What is claimed is:

1. A registration agent system which is provided in a network comprising nodes and at least one database for storing the correspondence of the IP address and the host name of each node, wherein said registration agent system comprises:
a registration request reception means including a host name and IP address from a node newly added to said network,
a searching means that instead of that node, searches said database using the host name included in the registration request received, and
a registration means that instead of that node, registers that host name and the IP address of the node concerned in said database if the result of the searching by said searching means is that that host name is not registered.

2. A registration agent system according to claim 1 wherein a plurality of databases are installed one in each different domain for storing the correspondence of an IP address and a host name in said network and wherein said registration agent system comprises a means for specifying from those databases the individual database that is for the domain pertaining to the IP address subject to searching and registration operations.

3. A registration agent system according to claim 2 which further comprises a generating means for generating as the host name for registration in the specified database, a host name included in a registration request from the node added to the network, which host name has attached domain information containing added information on the domain pertaining to the IP address of such newly added node.

4. A registration agent system according to claim 1 wherein said registration request reception means comprises;
a storage means for storing characters use of which is prohibited, and
a means for refusing a registration request that contains a host name using a character stored in this storage means.

5. A registration agent system according to claim 1 which further comprises a detection means for detecting a node newly added to the network, wherein said detection means comprises:
a means for recognizing the IP address of such detected node,
a means for generating a host name of the node corresponded to such recognized IP address, and
a means for transmitting, that, instead of said node newly added to the network, transmits to said registration request reception means a registration request including the generated host name and the IP address.

6. A registration agent system according to claim 1 which further comprises:
a preliminary searching means that operates before a searching from said searching means, to search said database using the IP address included in a received registration request, and
an invalidating means that operates when the result of such searching operation by the preliminary searching means indicates that registration of the IP address is already complete, to invalidate the registration request before the searching operation by the searching means using the host name is performed.

7. A network system in which is provided a registration agent system according to any of claims 1 through 6.

8. A computer program which can be installed in a computer system to realize functions for:
receiving a registration request including a host name and IP address from a node newly added to the network in which that information processing system is installed,
searching, instead of that node searching, at least one database installed in said network for storing the correspondence of host name and IP address for each individual node for the host name included in the registration request received, and
registering that host name and relevant IP address in said database if the result of that searching is that the host name is not registered.

9. A computer program according to claim 8 which is installed in a computer system operating in said network, wherein a plurality of databases are installed one in each different domain for storing the correspondence of an IP address and a host name in said network, which computer program realizes a function for specifying from those databases the individual database that is for the domain pertaining to the IP address subject to the searching and registration operations.

10. A computer program according to claim 9 which further realizes a function for generating as the host name for registration in the specified database, a host name included in a registration request from the node added to the network, which host name has attached domain information containing added information on the domain pertaining to the IP address of the node.

11. A computer program according to claim 8 wherein said function for receiving a registration request realizes functions for;
storing characters use of which is prohibited, and
refusing a registration request that contains a host name using characters stored through the function for storing characters.

12. A computer program according to claim 8 which further realizes a function for detecting a node newly added to the network, wherein said function for detecting realizes functions for:
recognizing the IP address of such detected node,
generating a host name of the node corresponded to such recognized IP address, and
transmitting, that acts instead of said node newly added to the network, to transmit to said function for receiving a registration request a registration request including the generated host name and the IP address.

13. A computer program according to claim 8 which further realizes functions for:
preliminary searching said specified database for the IP address included in a received registration request before searching for the host name, and
invalidating, when the result of such preliminary searching operation indicates that registration of the IP address is already complete, the registration request before searching for the host name.
